(19) United States
(12) Patent Application Publication
(10) Pub. No.: US 2021/0405401 A1
(43) Pub. Date: Dec. 30, 2021

(54) DEVICE FOR MANUFACTURING METAL LINES AND METHOD OF MANUFACTURING METAL LINES

(71) Applicant: TCL China Star Optoelectronics Technology Co., Ltd., Shenzhen (CN)

(72) Inventor: Xia ZHANG, Shenzhen (CN)

(73) Assignee: TCL China Star Optoelectronics Technology Co., Ltd., Shenzhen (CN)

(21) Appl. No.: 16/647,509

(22) PCT Filed: Dec. 30, 2019
(86) PCT No.: PCT/CN2019/129776

§ 371 Date: Mar. 15, 2020

(30) Foreign Application Priority Data
Dec. 12, 2019 (CN) 201911270612.1

(51) Int. Cl. G02F 1/13; G02F 1/1362

(52) U.S. Cl. CPC G02F 1/1303; G02F 1/136295

(57) ABSTRACT

The present disclosure provides a device for manufacturing metal lines and a method of manufacturing metal lines. The device for manufacturing metal lines includes a metal line forming component and a metal line dissolving component. The metal line forming component forms the first metal line from the first solution, then the metal line dissolving component dissolves a portion of the first metal line with a second solution to form a second metal line. Therefore, a size of the first metal line is reduced to form the second metal line, thereby solving a problem of too-large widths between metal lines in conventional display panels.

### FIELD

The present disclosure relates to the field of display and, more particularly, relates to a device for manufacturing metal lines and a method of manufacturing metal lines.

### BACKGROUND

In convention liquid crystal display (LCD) panels, an aperture of display panels is increased to realize a high resolution. Correspondingly, widths between metal lines need to be reduced. However, limited by resolutions of exposure machines for manufacturing conventional LCD panels, widths between conventional metal lines are too large, thereby significantly affecting improvement of resolution.

Consequently, there is a problem of too-large widths between metal lines in conventional display panels.

### SUMMARY

The present disclosure provides a device for manufacturing metal lines and a method of manufacturing metal lines to solve a problem of too-large widths between metal lines in conventional display panels.

To solve the above problem, technical solutions provided by the present disclosure are described below.

The present disclosure provides a device for manufacturing metal lines, including: a supporting platform for supporting a substrate; a metal line forming component for forming a first metal line from a first solution; and a metal line dissolving component for dissolving a portion of the first metal line with a second solution to form a second metal line.

In the device for manufacturing metal lines provided by the present disclosure, the metal line forming component includes a curing light source, a reflector, and an objective lens, the curing light source is configured to emit curing light to cure the first solution to form the first metal line, the reflector is configured to reflect the curing light to the first solution, and the objective lens is configured to accumulate the curing light.

In the device for manufacturing metal lines provided by the present disclosure, the reflector is a movable reflector, and the movable reflector is configured to reflect the curing light in different directions.

In the device for manufacturing metal lines provided by the present disclosure, the metal line forming component includes a plurality of curing light sources and a plurality of light blocking plates, the curing light sources and the light blocking plates cross each other, the curing units are configured to emit curing light to cure the first solution to form the first metal line, and the light blocking plates are configured to prevent the curing light from irradiating an area outside the first metal line.

In the device for manufacturing metal lines provided by the present disclosure, the device for manufacturing metal lines includes a first solution containing component, and the first solution containing component is configured to contain the first solution and drop the first solution onto the substrate.

In the device for manufacturing metal lines provided by the present disclosure, the first solution containing component includes a bottom plate and a cover plate, a containing space is formed between the bottom plate and the cover plate, the first solution is disposed in the containing space, and a movable hole is defined on the bottom plate and is configured to drop the first solution onto the substrate.

In the device for manufacturing metal lines provided by the present disclosure, the metal line dissolving component includes a second solution containing unit, a third solution containing unit, a second solution disposed in the second solution containing unit, and a third solution disposed in the third solution containing unit; and the second solution is configured to dissolve a portion of the first metal line to form a second metal line, and the third solution is configured to wash the second metal line.

In the device for manufacturing metal lines provided by the present disclosure, the metal line dissolving component includes a control unit configured to control flow of the second solution.

In the device for manufacturing metal lines provided by the present disclosure, the device for manufacturing metal lines includes a dry component configured to dry the second metal line.

In the device for manufacturing metal lines provided by the present disclosure, the second solution includes at least one of hydrogen chloride solution or magnesium chloride solution.

In the device for manufacturing metal lines provided by the present disclosure, the third solution includes water.

In the device for manufacturing metal lines provided by the present disclosure, the device for manufacturing metal lines includes a template manufacturing component and a template removing component, the template manufacturing component is configured to manufacture a template on the substrate, the template is configured to confine an area where the first solution is dropped, and the template removing component is configured to remove the template after the second metal line is formed.

In the device for manufacturing metal lines provided by the present disclosure, the first solution includes a metal precursor solution.

In the device for manufacturing metal lines provided by the present disclosure, the metal precursor solution includes an acrylate metal precursor, acrylate, an acrylic resin, a two-photon initiator, a solvent, and additives.

Furthermore, the present disclosure provides a method of manufacturing metal lines, including: providing a supporting platform, wherein the supporting platform supports a substrate; forming a first metal line from a first solution by a metal line forming component; and dissolving a portion of the first metal line by a metal line dissolving component with a second solution to form a second metal line.

The method further includes: forming a template on the substrate by a template manufacturing component, wherein the template is configured to confine an area where the first solution is dropped.

The method further includes: removing the template on the substrate by a template removing component after the second metal line is formed.

In the method provided by the present disclosure, a step of forming the first metal line from the first solution by the metal line forming component includes: curing the first solution by curing light emitted from a curing light source to form the first metal line.

The method further includes: containing the first solution in a first solution containing component.

The method further includes: containing the second solution by a second solution containing component.

Regarding the beneficial effects: the present disclosure provides a device for manufacturing metal lines and a method of manufacturing metal lines. The device for manufacturing metal lines includes a supporting platform, a metal line forming component, and a metal dissolving component. The supporting platform is configured to support a substrate, the metal line forming component is configured to form a first metal line from a first solution, and the metal line dissolving component is configured to dissolve a portion of the first metal line to form a second metal line. The metal line forming component forms the first metal line from the first solution, then the metal line dissolving component dissolves a portion of the first metal line with a second solution to form a second metal line. Therefore, a size of the first metal line is reduced to form the second metal line, thereby solving a problem of too-large widths between metal lines in conventional display panels.

### DESCRIPTION OF DRAWINGS

FIG. 1 is a first schematic view showing a device for manufacturing metal lines according to an embodiment of the present disclosure.

FIG. 2 is a second schematic view showing a device for manufacturing metal lines according to an embodiment of the present disclosure.

FIG. 3 is a flowchart showing a method of manufacturing metal lines according to an embodiment of the present disclosure.

FIG. 4 is a schematic view showing metal lines according to an embodiment of the present disclosure.

### DETAILED DESCRIPTION

Embodiments are described below in detail with reference to accompanying drawings to make objectives, technical solutions, and effects of the present disclosure clearer and easier to be understood. It should be noted that described embodiments are merely used to construct the present disclosure and are not intended to limit the present disclosure.

The present disclosure can solve a problem of too-large widths between metal lines in conventional display panels.

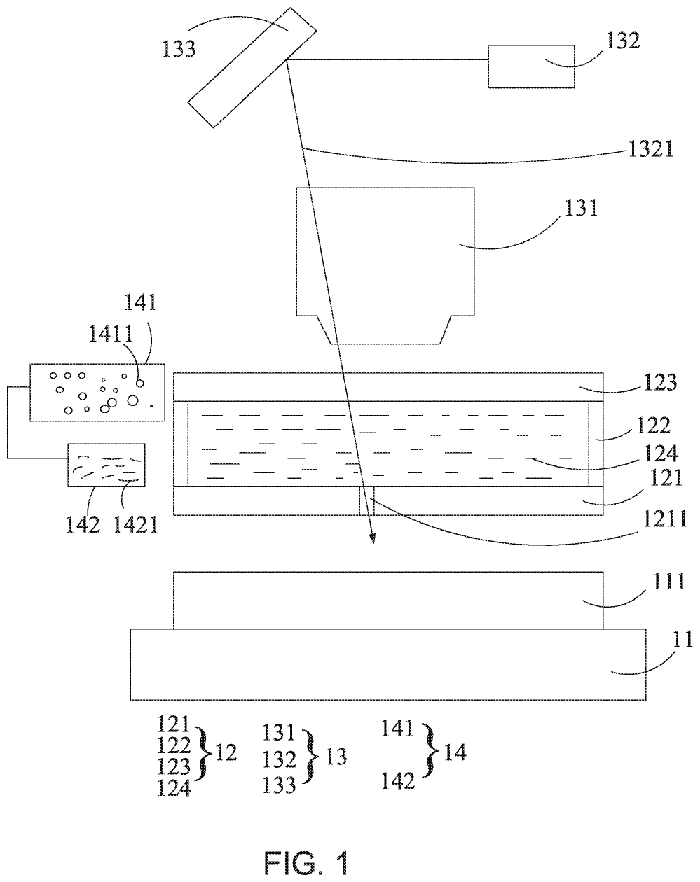

As shown in FIG. 1, the present disclosure provides a device for manufacturing metal lines, including: a supporting platform 11 for supporting a substrate 111; a metal line forming component 13 for forming a first metal line from a first solution 124; and a metal line dissolving component 14 for dissolving a portion of the first metal line with a second solution 1411 to form a second metal line.

An embodiment of the present disclosure provides a device for manufacturing metal lines. The device for manufacturing metal lines includes a supporting platform, a metal line forming component, and a metal dissolving component. The supporting platform is configured to support a substrate, the metal line forming component is configured to form a first metal line from a first solution, and the metal line dissolving component is configured to dissolve a portion of the first metal line to form a second metal line. The metal line forming component forms the first metal line from the first solution, then the metal line dissolving component dissolves a portion of the first metal line with a second solution to form a second metal line. Therefore, a size of the first metal line is reduced to form the second metal line, thereby solving a problem of too-large widths between metal lines in conventional display panels.

It should be noted that the metal lines include metal wires, metal patterns, but are not limited thereto. The metal lines include all wires or electrodes, which are made of metals.

In one embodiment, as shown in FIG. 1, the metal line forming component 13 includes a curing light source 132, a reflector 133, and an objective lens 131. The curing light source 132 is configured to emit curing light 1321 to cure the first solution 124 to form the first metal line, the reflector 133 is configured to reflect the curing light 1321 to the first solution 124, and the objective lens 131 is configured to accumulate the curing light 1321. By cooperation of the curing light source 132, the reflector 133, and the objective lens 131, the curing light 1321 emitted from the curing light source 132 can irradiate the first solution 124 so that the first solution 124 can be cured to form the first metal line. Furthermore, considering that the curing light 1321 emitted from the curing light source 132 is divergent, the objective lens 131 is used to accumulate the curing light 1321 so that the curing light can focusedly irradiate the first solution 124, thereby quickly curing the first solution 124 to form the first metal line.

In one embodiment, the reflector is a movable reflector configured to reflect the curing light in different directions. Considering that the curing light needs to be accumulated in a predetermined area where the first metal line is formed to form the first metal line, the reflector may be a movable reflector. By moving the movable reflector to control an incident angle of the curing light, the first solution can be cured in the predetermined area to form the first metal line. The movable reflector can be rotated along any direction to reflect the curing light.

In one embodiment, the metal line forming component includes a plurality of curing light sources and a plurality of light blocking plates, and the curing light sources and the light blocking plates cross each other. The curing units are configured to emit curing light to cure the first solution to form the first metal line, and the light blocking plates are configured to prevent the curing light from irradiating an area outside the first metal line, that is, the curing light irradiates the predetermined area, and the predetermined area is a first metal line area. The light blocking plates and the curing light sources cross each other so that the curing light can irradiate the first metal line area to cure the first solution to form the first metal line, and the first solution can be prevented from being cured outside the first metal line area. As a result, the first metal line is formed on the first metal line area only. Furthermore, the blocking plates can extend downward so that the curing light only irradiates areas between the blocking light plates. Therefore, areas irradiated by the curing light correspond to the first metal line area.

In one embodiment, the device for manufacturing metal lines further includes a dry unit, and the dry unit is configured to dry the second metal line so that the first metal line can be attached to the substrate. To tightly attach the first metal line to the substrate, the first metal line can be dried by the dry unit after being formed, which gives a strong adhesion between the first metal line and the substrate. As a result, the first metal line can be tightly attached to the substrate.

In one embodiment, as shown in FIG. 1, the device for manufacturing metal lines further includes a first solution containing component 12 configured to contain the first solution 124 and drop the first solution 124 onto the substrate 111. To dispose the first solution on the first metal line area of the substrate, the first solution containing component can be used to contain the first solution and drop the first solution onto the substrate when the first metal line is to be formed.

In one embodiment, as shown in FIG. 1, the first solution containing component 12 includes a bottom plate 121 and a cover plate 123, a containing space is formed between the bottom plate 121 and the cover plate 123, and the first solution 124 is disposed in the containing space. A movable hole 1211 is defined on the bottom plate and is configured to drop the first solution 124 onto the substrate 111. When we want to drop the first solution 124 onto the substrate 111, the movable hole 1211 can be moved so that the first solution 24 can be dropped onto the substrate 111 through the movable hole 1211, thereby forming the first metal line on the substrate 111.

It should be noted that the movable hole is provided in plural, while FIG. 1 only demonstrates one movable hole. The movable hole corresponds to the first metal line area.

In one embodiment, as shown in FIG. 1, a plurality of lateral plates 122 are formed from the cover plate 123 extending downward or are formed from the bottom plate 121. Alternatively, the lateral plates 122 can be independent and are disposed in an array in the containing space. An area confined by the lateral plates 122 corresponds to the first metal line area. By defining the movable hole in the area confined by the lateral plates 122, the first solution can be disposed in the area confined by the lateral plates 122 and can be dropped onto the substrate through the movable hole.

In one embodiment, as shown in FIG. 1, the metal line dissolving component 14 includes a second solution containing unit 141, a third solution containing unit 142, a second solution 1411 disposed in the second solution containing unit 141, and a third solution 1421 disposed in the third solution containing unit 142. The second solution 1411 is configured to dissolve a portion of the first metal line to form the second metal line, and the third solution 1421 is configured to wash the second metal line. To reduce widths of metal lines, metal line dissolving components can be used to dissolve the first metal line after the metal line is formed. As a result, a width of the first metal line is reduced, a thickness of the first metal line is simultaneously reduced, and miniaturized metal wires can be realized.

In one embodiment, the second solution containing unit contains the second solution. The second solution is dropped or poured on the first metal line by the second solution containing unit to dissolve the first metal line, thereby forming a second metal line. A width of the first metal line is reduced to form the second metal line with a smaller width. Furthermore, the portion of the first metal line which is dissolved by the second solution can be adjusted, for example, a thickness and a width of the first metal line can be reduced together to realize miniaturized metal wires.

In one embodiment, to prevent the second solution from remaining on the second metal line and keeping eroding the second metal line, the third solution containing unit can be further disposed. Specifically, pouring the third solution on the second metal line by the third solution containing unit to remove the second solution.

In one embodiment, the first metal line is be dissolved with the second solution, the first metal line is dissolved with the second solution again after a short interval, and the first metal line is washed with the third solution after a short interval until the second metal line is formed. The present embodiment can prevent the first metal line from being broken by the second solution and from failure. Alternatively, after the second metal line is formed by dissolving the first metal line with the second solution, washing the second metal line with the third solution. Therefore, the second metal line can be quickly formed, and costs can be reduced.

In one embodiment, the second solution containing unit is connected to the third solution containing unit. The second solution containing unit and the third solution containing unit can be disposed in a stack. The second solution containing unit and the third solution containing unit can be moved so that they can be used alternately or simultaneously. Alternatively, the second solution containing unit and the third solution containing unit can be disposed in a same plane, and they can be used alternately or simultaneously by moving the metal line dissolving component. Furthermore, the metal dissolving unit is connected to the supporting platform and can be stretched so that the metal line dissolving component can be moved above the first metal line to dissolve the first metal line, or the metal line dissolving component can be moved along the support platform to be above the first metal line.

In one embodiment, the metal line dissolving component further includes a control unit configured to control flow of the second solution. When dissolving the first metal line by the second solution, flow of the second solution needs to be controlled to prevent the first metal line from being overly eroded with the second solution, form being perforated because of erosion, and from failure. By using the control unit to control flow of the second solution, usage time of the second solution can be controlled. Therefore, the second solution can dissolve a portion of the first metal line to form the second metal line that is required.

In one embodiment, the device for manufacturing metal lines further includes a dry component configured to dry the second metal line. After the second metal line is washed with the third solution, the second metal line can be dried to remove the third solution and the second solution. Therefore, the clean second metal line can be obtained.

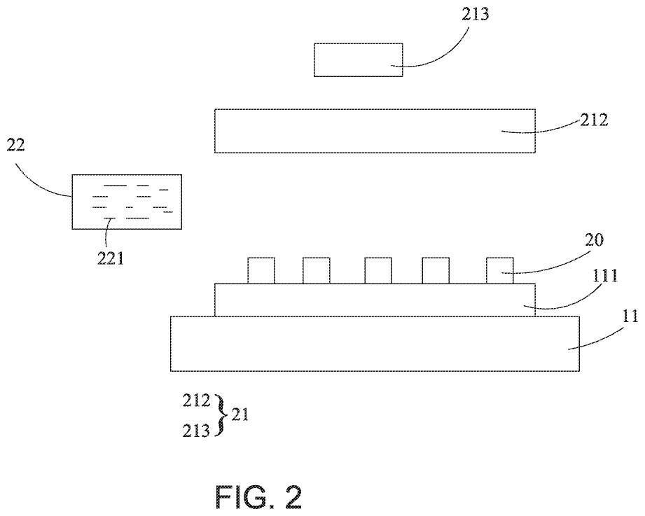

In one embodiment, as shown in FIG. 2, the device for manufacturing metal lines further includes a template manufacturing component 21 and a template removing component 22, the template manufacturing component 21 is configured to manufacture a template 20 on the substrate 111, the template 20 is configured to confine an area where the first solution is dropped, and the template removing component 22 is configured to remove the template 20 after the second metal line is formed. To prevent the first metal line from being formed outside the first metal line area, the template is formed on an area outside the first metal line area to confine the first metal line area when the first metal line is formed. Therefore, the first metal line can be formed on the first metal line area. Furthermore, after the second metal line is formed, the template is removed by the template removing component, thereby preventing the template from occupying space and from affecting the second metal line.

In one embodiment, as shown in FIG. 2, the template manufacturing component 21 includes an exposure light source 213 and a mask 212. By cooperation of the exposure light source 213 and the mask 212, a template layer formed on the substrate can be removed to form the template 20. The template removing component 22 includes a fourth solution configured to remove the template 20. The template 20 can be removed with the fourth solution after the second metal line is formed, thereby preventing the second metal line from being affected.

In one embodiment, the fourth solution includes an alkaline solution, such as sodium hydroxide, but is not limited thereto. However, if possible, the fourth solution should be a solution that will not dissolve the second metal line.

In one embodiment, the second solution includes at least one of a hydrogen chloride solution or a magnesium chloride solution. Considering that the metal lines are made of metals, the first metal line is dissolved with an acid solution or a salt solution which can react with metals, but the second solution is not limited thereto. The second solution includes solutions that can dissolve the first metal line.

In one embodiment, the third solution includes water, but is not limited thereto. The second solution may also be removed with an alkaline solution or an acid solution as long as the third solution does not affect the second solution.

In one embodiment, the first solution includes a metal precursor solution. The first solution is consisting of a metal complex and an acrylate hydrogel solution.

In one embodiment, the metal precursor solution includes an acrylate metal precursor, acrylate, an acrylic resin, a two-photon initiator, a solvent, and additives. Furthermore, to achieve a better effect, the proportion of each component is limited. For example, a mass ratio of the metal precursor solution ranges from 10% to 60%, a mass ratio of the acrylate ranges from 10% to 20%, a mass ratio of the acrylic resin ranges from 1% to 30%, a mass ratio of the two-photon initiator ranges from 0.5% to 10%, a mass ratio of the additives ranges from 0.5% to 2%, and a mass ratio of the solvent is decided by mass ratios of other components and is 100% minus a sum of the mass ratios of other components.

In one embodiment, a chemical formula of the acrylate metal precursor is:

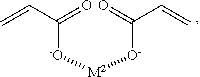

wherein M is one selected from the group consisting of Ag, Au, Cu, Mg, Al, and Zn, and the metal precursor solution may include diverse acrylate metal precursors.

In one embodiment, a chemical formula of the acrylate is:

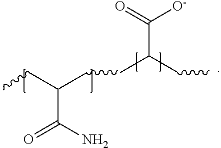

In one embodiment, the acrylate includes an acrylate monomer with multiple functional groups.

In one embodiment, a chemical formula of the two-photon initiator is:

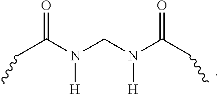

In one embodiment, the additives include a leveling aid and an adhesion aid.

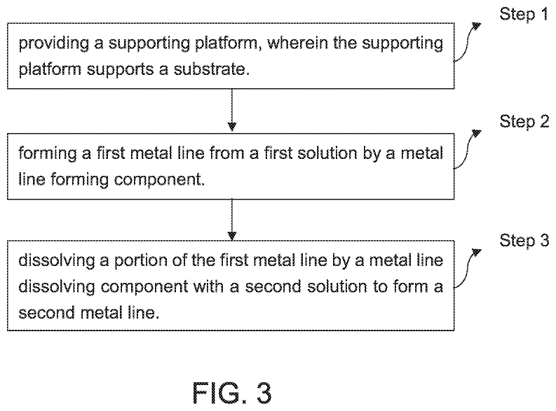

As shown in FIG. 3, an embodiment of the present disclosure provides a method of manufacturing metal lines, including:

Step 1: providing a supporting platform, wherein the supporting platform supports a substrate;

Step 2: forming a first metal line from a first solution by a metal line forming component; and

Step 3: dissolving a portion of the first metal line by a metal line dissolving component with a second solution to form a second metal line.

The present disclosure provides a method of manufacturing metal lines. The device for manufacturing metal lines used in the method includes a supporting platform, a metal line forming component, and a metal dissolving component. The supporting platform is configured to support a substrate, the metal line forming component is configured to form a first metal line from a first solution, and the metal line dissolving component is configured to dissolve a portion of the first metal line to form a second metal line. The metal line forming component forms the first metal line from the first solution, then the metal line dissolving component dissolves a portion of the first metal line with a second solution to form a second metal line. Therefore, a size of the first metal line is reduced to form the second metal line, thereby solving a problem of too-large widths between metal lines in conventional display panels.

In one embodiment, the method further includes: forming a template on the substrate by a template manufacturing component, wherein the template is configured to confine an area where the first solution is dropped. The template is formed on the substrate before the first metal line is formed so that the first metal line can be formed on a first metal line area.

In one embodiment, the method further includes: removing the template on the substrate by a template removing component after the second metal line is formed. The template is removed after the second metal line is formed, thereby preventing the second metal line from being affected.

In one embodiment, a step of forming the first metal line from the first solution by the metal line forming component includes: curing the first solution by curing light emitted from a curing light source to form the first metal line.

In one embodiment, the method further includes: containing the first solution in a first solution containing component, and using the first solution containing component to dispose the first solution on the substrate.

In one embodiment, the method further includes: containing the second solution in a second solution containing component, and using the second solution containing component to dissolve the first line with the second solution.

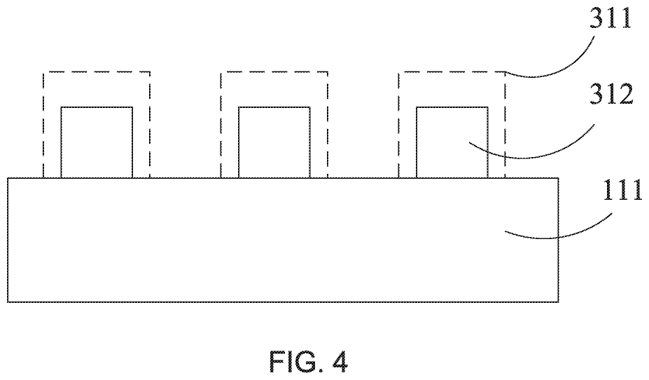

As shown in FIG. 4, which is a schematic view showing the metal lines according to an embodiment of the present disclosure, the second metal line 312 is formed after the first metal line 311 is formed and dissolved. As we can see in FIG. 4, a width and a thickness of the second metal line 312 are less than that of the first metal line 311. In actual requirements, a smaller first metal line 311 can be formed, and the second metal line 322 is formed by dissolving the first metal line 311, thereby realizing miniaturized metal wires.

According to the above embodiments, the present disclosure provides a device for manufacturing metal lines and a method of manufacturing metal lines. The device for manufacturing metal lines includes a supporting platform, a metal line forming component, and a metal dissolving component. The supporting platform is configured to support a substrate, the metal line forming component is configured to form a first metal line from a first solution, and the metal line dissolving component is configured to dissolve a portion of the first metal line to form a second metal line. The metal line forming component forms the first metal line from the first solution, then the metal line dissolving component dissolves a portion of the first metal line with a second solution to form a second metal line. Therefore, a size of the first metal line is reduced to form the second metal line, thereby solving a problem of too-large widths between metal lines in conventional display panels.

In summary, many changes and modifications to the described embodiment can be carried out by those skilled in the art, and all such changes and modifications are intended to be included within the scope of the appended claims.

1. A device for manufacturing metal lines, comprising:
a supporting platform for supporting a substrate;
a metal line forming component for forming a first metal line from a first solution; and
a metal line dissolving component for dissolving a portion of the first metal line with a second solution to form a second metal line.

2. The device for manufacturing metal lines according to claim 1, wherein the metal line forming component comprises a curing light source, a reflector, and an objective lens, the curing light source is configured to emit curing light to cure the first solution to form the first metal line, the reflector is configured to reflect the curing light to the first solution, and the objective lens is configured to accumulate the curing light.

3. The device for manufacturing metal lines according to claim 2, wherein the reflector is a movable reflector, and the movable reflector is configured to reflect the curing light in different directions.

4. The device for manufacturing metal lines according to claim 1, wherein the metal line forming component comprises a plurality of curing light sources and a plurality of light blocking plates, the curing light sources and the light blocking plates cross each other, the curing light sources are configured to emit curing light to cure the first solution to form the first metal line, and the light blocking plates are configured to prevent the curing light from irradiating an area outside the first metal line.

5. The device for manufacturing metal lines according to claim 1, wherein the device for manufacturing metal lines comprises a first solution containing component, and the first solution containing component is configured to contain the first solution and drop the first solution onto the substrate.

6. The device for manufacturing metal lines according to claim 5, wherein the first solution containing component comprises a bottom plate and a cover plate, a containing space is formed between the bottom plate and the cover plate, the first solution is disposed in the containing space, and a movable hole is defined on the bottom plate and is configured to drop the first solution onto the substrate.

7. The device for manufacturing metal lines according to claim 1, wherein the metal line dissolving component comprises a second solution containing component, a third solution containing component, a second solution disposed in the second solution containing component, and a third solution disposed in the third solution containing component; and
the second solution is configured to dissolve a portion of the first metal line to form a second metal line, and the third solution is configured to wash the second metal line.

8. The device for manufacturing metal lines according to claim 7, wherein the metal line dissolving component comprises a control unit configured to control flow of the second solution.

9. The device for manufacturing metal lines according to claim 7, wherein the device for manufacturing metal lines comprises a dry component configured to dry the second metal line.

10. The device for manufacturing metal lines according to claim 7, wherein the second solution comprises at least one of hydrogen chloride solution or magnesium chloride solution.

11. The device for manufacturing metal lines according to claim 7, wherein the third solution comprises water.

12. The device for manufacturing metal lines according to claim 1, wherein the device for manufacturing metal lines comprises a template manufacturing component and a template removing component, the template manufacturing component is configured to manufacture a template on the substrate, the template is configured to confine an area where the first solution is dropped, and the template removing component is configured to remove the template after the second metal line is formed.

13. The device for manufacturing metal lines according to claim 1, wherein the first solution comprises a metal precursor solution.

14. The device for manufacturing metal lines according to claim 13, wherein the metal precursor solution comprises an acrylate metal precursor, acrylate, an acrylic resin, a two-photon initiator, a solvent, and additives.

15. A method of manufacturing metal lines, comprising:
providing a supporting platform, wherein the supporting platform supports a substrate;
forming a first metal line from a first solution by a metal line forming component; and
dissolving a portion of the first metal line by a metal line dissolving component with a second solution to form a second metal line.

16. The method according to claim 15, wherein the method comprises:
forming a template on the substrate by a template manufacturing component, wherein the template is configured to confine an area where the first solution is dropped.

17. The method according to claim 16, wherein the method comprises:
removing the template on the substrate by a template removing component after the second metal line is formed.

18. The method according to claim 15, wherein a step of forming the first metal line from the first solution by the metal line forming component comprises:
curing the first solution by curing light emitted from a curing light source to form the first metal line.

19. The method according to claim 15, wherein the method comprises:
containing the first solution in a first solution containing component.

20. The method according to claim 15, wherein the method comprises:
containing the second solution by a second solution containing component.
